(19) United States
(12) Patent Application Publication
(10) Pub. No.: US 2015/0262301 A1
(43) Pub. Date: Sep. 17, 2015

(54) SYSTEMS AND METHODS FOR PROVIDING GIFT CERTIFICATES OF STOCK

(71) Applicant: Stockpile, Inc., Palo Alto, CA (US)

(72) Inventors: Avinash S. Lele, Palo Alto, CA (US); Sanjeev R. Kulkarni, Princeton, NJ (US)

(73) Assignee: Stockpile, Inc., Palo Alto, CA (US)

(21) Appl. No.: 14/724,377

(22) Filed: May 28, 2015

Related U.S. Application Data
(63) Continuation of application No. 13/022,309, filed on Feb. 7, 2011, now abandoned.

(51) Int. Cl. G06Q 40/04

(52) U.S. Cl. CPC G06Q 40/04

(57) ABSTRACT

A system and method for gift certificates of securities, other financial instruments, commodities, or other assets are disclosed. In the case of stock, a purchaser enters gift certificate parameters including company name and denomination, as well as payment information. These parameters, together with the market price of the stock, determine the number of shares (which may be a non-integer number) that are being gifted. A provider generates an identifier, part or all of which may be incorporated into a physical or electronic gift certificate for delivery to a recipient who may claim the stock. A database maintains records of the gift certificates that have been purchased and claimed.

### CROSS REFERENCE TO RELATED APPLICATION

The present application is a continuation application and claims priority of U.S. patent application Ser. No. 13/022,309, filed Feb. 7, 2011, titled Systems and Methods for Providing Gift Certificates of Stock which is incorporated herein by reference.

### BACKGROUND

The present disclosure is directed to systems and methods for conveying gifts of stock, bonds, commodities, other financial instruments, and other assets in any desired amount.

Relatives such as parents and grandparents sometimes give shares of stock or other securities as gifts to their children or grandchildren. Such gifts last far beyond the time they are given, have educational value, have the potential to appreciate in value, and may be held long-term as a valuable investment.

Despite having these desirable qualities, however, stock traditionally has not been a practical gift-giving option. Having to purchase it in integer share amounts often makes it too expensive to give as a gift. For example, someone might want to give Apple Inc. stock as a birthday gift to a child who is interested in computers. But a share of Apple stock trading at $300 per share might be too expensive as a child's birthday gift. As a result, for all practical purposes, the gift-giver's choices may be restricted to stocks that are within an appropriate price range (e.g., stocks priced at $20 to $30 per share). See, e.g., www.oneshare.com, which enables the gift giver to shop for stocks by price at the URL http://www.oneshare.com/StocksPrice.aspx.

Furthermore, where a physical stock certificate is being gifted, it can take weeks for the recipient to receive the stock certificate, which, even if the purchaser plans well in advance, may detract from the gift-giving experience. See, e.g., www.oneshare.com, www.giveashare.com, www.shareinaframe.com, and www.frameastock.com.

It is also possible to give a gift of stock through a company's direct reinvestment plan (“DRIP”), but a minimum initial purchase of one share is required, and such a gift cannot be made for companies that do not offer DRIPs. See, e.g., www.giftsofstock.com and the Texaco Investor Services Plan, described at the URL http://www.secinfo.com/d2v2a.7d.htm.

The fluctuating value of stock can present another problem. Someone might want to give a gift of Home Depot stock, but a share of that stock could be trading at one price today and a very different price a month from now due to market fluctuations. As a result, someone who would like to buy a share of Home Depot stock as a gift might have to think twice if the price goes up by the time he gets around to actually making the purchase. Or, if the stock goes down between the time of the purchase and delivery of the gift, the purchaser may feel bad giving a gift worth less than what she paid and/or what she desired to give.

Moreover, the mechanism for transferring stock in street name (i.e., where the stock is held in a brokerage account instead of as a physical certificate) is cumbersome and ill-suited for gift giving. To give a gift of stock, a person typically has a brokerage account of his own. The intended recipient also has a brokerage account, and the gift-giver knows the recipient's brokerage account information. Then, the gift-giver either already has in his account the stock he wants to give or buys the stock for his account, and then issues instructions to his brokerage to transfer the stock to the recipient's brokerage account.

In addition, if the gift-giver wishes to give an amount of stock that corresponds to a non-integer number of shares (e.g., $25 of McDonald's stock where one share is trading at $75), both accounts may need to accommodate fractional shares, which many brokerages do not offer. In addition, compliance with regulatory requirements may limit the potential providers and purchasers of the gift certificates for stock because there is currently no streamlined method for facilitating the purchase of the stock in non-standard amounts for the benefit of others.

As a result of problems such as these, a large number of potential gift transactions cannot be fulfilled with stock, even though the reasons for wanting to give stock can be compelling.

One alternative that is sometimes used is savings bonds. These come in denominations that are more suited to gift giving, and are more easily transferred from purchaser to recipient. However, savings bonds—particularly those with distant maturity dates—are easily misplaced. The recipient must take care to store the bond properly for safekeeping, but not forget all about it during the period leading up to maturity.

Two other alternatives are mutual funds, as well as gift cards or gift certificates whose value may be applied toward the opening and funding of a new brokerage account. Both may be purchased in arbitrary dollar amounts that make them more suited to gift giving. But to many people, neither makes a very appealing gift because neither is personalized to the individual tastes of a recipient, like a gift of an individual stock like Starbucks or Harley Davidson might be. See, e.g., U.S. Patent Application Pub. No. US 2008/0126211 A1, which describes a mutual fund gift card that may be issued in a selected denomination, and the ShareBuilder Gift of Stock, which includes a $50 ShareBuilder gift card that is redeemable only into a new ShareBuilder account, available at the URL haps://shop.ingdirect.com.

Still another gifting alternative is gift certificates or gift cards that are redeemable for merchandise at a particular retailer. However, they force the recipient to spend their value at the particular retailer, which may not be a place where the recipient wants to shop at the moment, and which may not even be a place where the recipient likes to shop. This restriction can make merchandise gift certificates and gift cards less valuable than an equivalent amount of cash. See, e.g., www.plasticjungle.com, where people can buy and sell gift cards at a discount to their face value. Gift certificates and gift cards from retailers also often end up lost or forgotten because they often are not redeemed shortly after being received. Another type of gift card may not be tied to a particular retailer, such as “pre-paid” gift cards. However, like cash, these prepaid cards do not afford affinity to a company like a gift of stock, nor do they afford the potential for financial appreciation of the gift that is available with stock. In addition, gift certificates and gift cards can have expiration dates that make them less suitable for long term investment.

Another problem with many gifts is that the identity of the gift-giver is easily forgotten over the years. One example is in the case of gifts to young recipients. By the time Junior is old enough to appreciate that his Aunt Edna gave him a $50 savings bond for his 5^{th} birthday, no one will even remember that it was Edna that gave the gift in the first place. This can be true in other situations, such as weddings or other occasions where the recipient receives a large number of gifts. Ten years later, it is hard to remember who gave the toaster.

Accordingly, there is a need for a system and method for enabling people to give gift certificates redeemable for an arbitrary amount of stock in one or more publicly traded companies, even to a recipient who may not already have a brokerage account or whose brokerage account information may not be known to the purchaser.

In one embodiment, the number of shares may include integer or non-integer numbers of shares (e.g., 0.25 shares, 4/3 shares, π shares) that may correspond to an arbitrary desired dollar amount of the stock (e.g., $25 worth of Company A's stock). The purchaser may visit a provider's website to select a stock (e.g., Company A's stock) and select either the dollar value of the gift certificate (e.g., $25) or the number of shares (e.g., 0.5 shares of Company A's stock). The purchaser may also provide additional information, such as credit card information to pay for the gift certificate, information needed to satisfy anti-money laundering (“AML”) laws, and the recipient's email address. An electronic gift certificate then may be emailed to the recipient, who, upon clicking on a link in the gift certificate, may be redirected to the provider's website to claim her stock. Once the recipient logs in or sets up an account, an appropriate number of shares of the designated company (or another company, if the system allows the recipient to override the purchaser's choice) may be credited to the recipient's provider account. This number of shares may be calculated or “fixed” at any of several points in time (e.g., at or sometime after the time of purchase or claiming), based on a market price of one share of the stock. The purchaser, as used in this discloser, is the gift giver who uses the systems and methods disclosed herein to provide a gift of stock to a recipient, without regard to whether the stock will be purchased in connection with the purchase of the gift certificate or already exists in, and is being gifted from, the purchaser's account.

In another embodiment, a gift certificate identifier (e.g., a serial number) may be created at the time the gift certificate is purchased and included on the face of the gift certificate. The purchaser then may print, e-mail, or otherwise communicate the gift certificate or the identifier to a recipient. The recipient may claim the stock associated with the gift certificate by communicating the identifier to the provider (e.g., by entering it at the provider's website, texting it to the provider, etc.) and logging into her existing provider account or opening an account with the provider. Optionally, the recipient may be required to communicate not only the identifier, but also additional claiming information (e.g., the denomination of the gift certificate, the recipient's phone number, etc.) to claim the stock.

In another embodiment, the gift certificate may be redeemable for asset classes other than or in addition to stock, e.g., $50 worth of gold, $50 worth of a specified futures contract for oil, $50 worth of a call option for a particular stock with a specified strike and expiration, $50 worth of a specified Treasury bond, $50 worth of Japanese Yen, etc. Like in gifts of stock, the present disclosure facilitates gifts of arbitrary amounts for these asset classes that traditionally are publicly traded in integer numbers of some minimum unit (e.g., one ounce) rather than in an arbitrary desired monetary amount.

In another embodiment, the purchaser may create what is called a “Flexertificate” by designating a group of stocks personalized to the recipient's tastes. For example, for a child who likes to read and play sports, the purchaser could purchase a $50 gift certificate redeemable for shares of Barnes & Noble, Amazon, or Nike. The allocation among those companies (e.g., $10 of Barnes & Noble, $10 of Amazon, and $30 of Nike) may be chosen by the purchaser or the recipient. Or, the purchaser may give a Flexertificate redeemable for any of the stocks (or other assets) allowed by the system.

In another embodiment, a gift history may maintain a record of gifts purchased and received by registered users of the system. Information for a received gift may include the purchaser's name, the gift that was given, a gift message, and/or the date of the gift. Correspondingly, information for a purchased gift may include the recipient's name, the gift that was given, gift message, date, claim status, and/or “thank you” reply message from the recipient. Registered users may view their gift histories as desired.

In another embodiment, the purchaser may be sent an automatic reminder based on an earlier purchase of a gift certificate. For example, a year later, the purchaser might be sent an email that says: “You purchased a $20 gift certificate of Company B for Kristina last year. Her birthday is just around the corner—would you like to do the same this year?” The system may also provide a way for a purchaser to purchase multiple gift certificates ahead of time (e.g., once at the beginning of each year) and have them automatically printed out and mailed (or emailed, or otherwise transferred) by the provider to the recipient on the designated dates. Alternatively, the system may allow a purchaser to designate a number of potential gifts at future dates and have the system send reminders as these dates approach to prompt the purchaser to purchase the potential gifts.

In another embodiment, a recipient may set up a gift registry to specify his or her desire to receive gifts (e.g., in connection with an event or occasion such as a birthday, graduation, wedding, religious occasion, etc.), together with a list of gifts that are desired (e.g., stock in Companies A, B, and C, and gold). Others may view the list to purchase the specified gifts in desired amounts.

In another embodiment, interaction with another website may be enabled. For example, a gift registry could be established in conjunction with an invitation management website such as Evite. As another example, a customer of the provider who has a social networking webpage may display on that webpage information about his or her provider account (e.g., so that certain information, such as current portfolio value or a list of stock holdings, is viewable on that webpage without having to visit the provider website, or so as to alert friends, e.g., that he is a customer of the provider, just gave someone a gift of stock using the provider's system, or has set up a wish list of stocks that he would appreciate receiving for an upcoming occasion). Conversely, information appearing on the social networking website may be obtained for use at the provider's website (e.g., the birthdays of family and friends). Likewise, searches of the web pages of the friends or family of a customer could be conducted periodically, e.g., to make gift giving suggestions. As another example, a retail brokerage firm may include on their webpage or a page as part of a customer's account links to purchase a gift certificate or to information on gifts desired by other customers that have some relationship with the account holder.

In this manner, the systems and methods of present disclosure enable people to give gifts of stock even to a recipient who may not already have a brokerage account or whose account information may not be known to the purchaser. Purchasers also may choose a stock and a dollar amount independently of each other. This decoupling makes it feasible to give as gifts even those stocks whose share price might be too high to be given in an integer number of shares.

### BRIEF DESCRIPTION OF THE DRAWINGS

FIG. 1 is a simplified block diagram of one embodiment of the present disclosure.

FIGS. 2A-2G illustrate one embodiment of a provider database and its contents.

FIGS. 3A and 3B illustrate a simplified flow diagram of one embodiment of a method for purchasing a gift certificate.

FIGS. 4A and 4B illustrate an exemplary gift certificate and screen display as a gift certificate is created.

FIGS. 5A and 5B illustrate a simplified flow diagram of one embodiment of a method for claiming the stock associated with a gift certificate.

FIG. 6 illustrates a simplified flow diagram of one embodiment of a method for controlling the provider's inventory of publicly traded shares.

### DETAILED DESCRIPTION

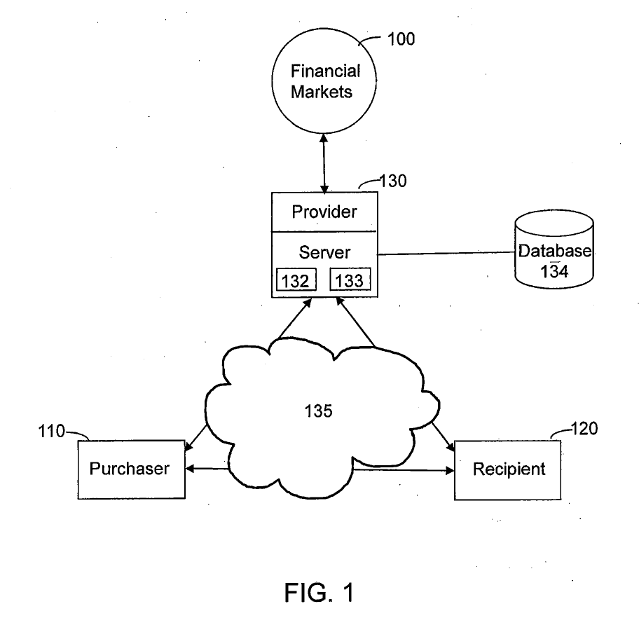

FIG. 1 shows a block diagram of one embodiment of the present disclosure. A purchaser 110, recipient 120, and provider 130 may be coupled to and communicate over a network 135 such as the Internet, by telephone, or otherwise. (Herein, we refer to purchasers 110 and recipients 120 alike as “customers,” “users,” or “end users.”) Provider 130 may be equipped with a server that hosts a website 132 having one or more web pages, runs software 133, and accesses a data memory such as a database 134. Provider 130 also may be coupled to and communicate with financial markets 100 in which shares of stock are publicly traded. The provider may be a brokerage house, a clearinghouse, a financial or investment advisor or a third party provider that ensures compliance with all regulatory requirements and facilitates establishing the required brokerage accounts, redeeming the gift certificates for the stock and transfer the purchased securities to the designated recipient.

In a manner well known in the art, purchaser 110 may use a personal computer, tablet computer, smart phone, or other device to connect to the network 135. Purchaser 110 may visit provider website 132 to purchase a gift certificate by providing information that includes gift certificate parameters (e.g., company name and denomination), the recipient's address (e.g., an email address), and payment information (e.g., credit card information). Purchaser 110 also may be required to provide additional information identifying the purchaser, and may be required to become a registered user of the provider.

After payment information has been verified, provider 130 generates a gift certificate that may be emailed to the recipient, who may enter an identifier and other claiming information such as anti-fraud information (part or all of which may appear on the face of the gift certificate) at the provider's website and either log in or set up a new account to claim her stock. The corresponding amount of stock then may be credited to the recipient's provider account.

Thereafter, recipient 120 may query provider database 134 to view the performance of her stocks, place a sell order for some or all of her holdings, buy more stock, or assume the role of a purchaser 110 in order to purchase a gift certificate for someone else. Provider 130 may operate as a registered broker-dealer to buy and sell integer numbers of shares of stock to cover the fractional holdings of its customers.

Although FIG. 1 depicts only one purchaser and one recipient, in general there may be a plurality of each.

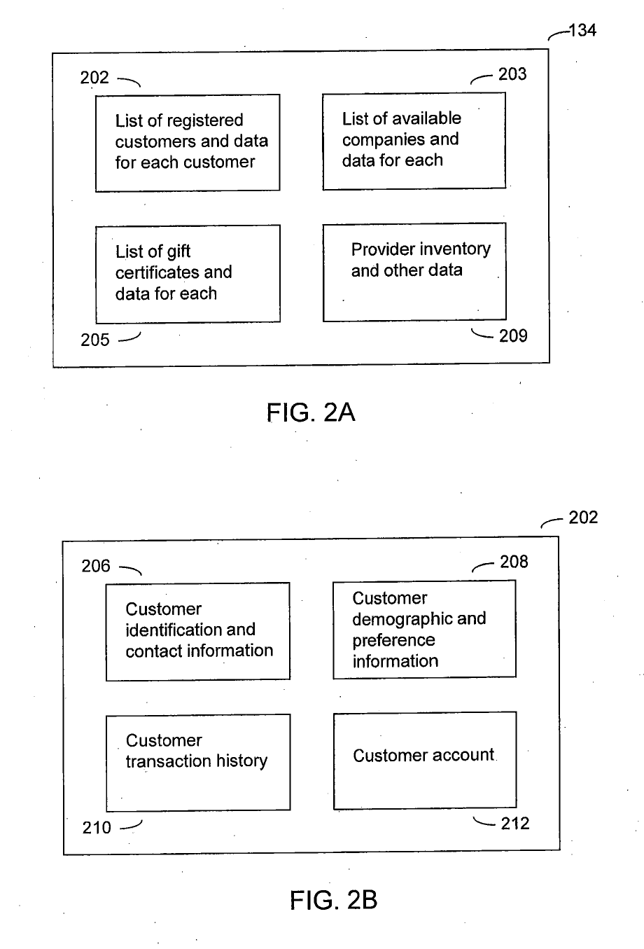

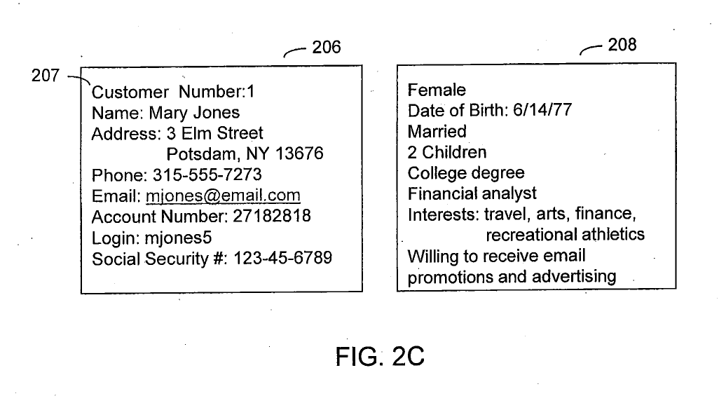

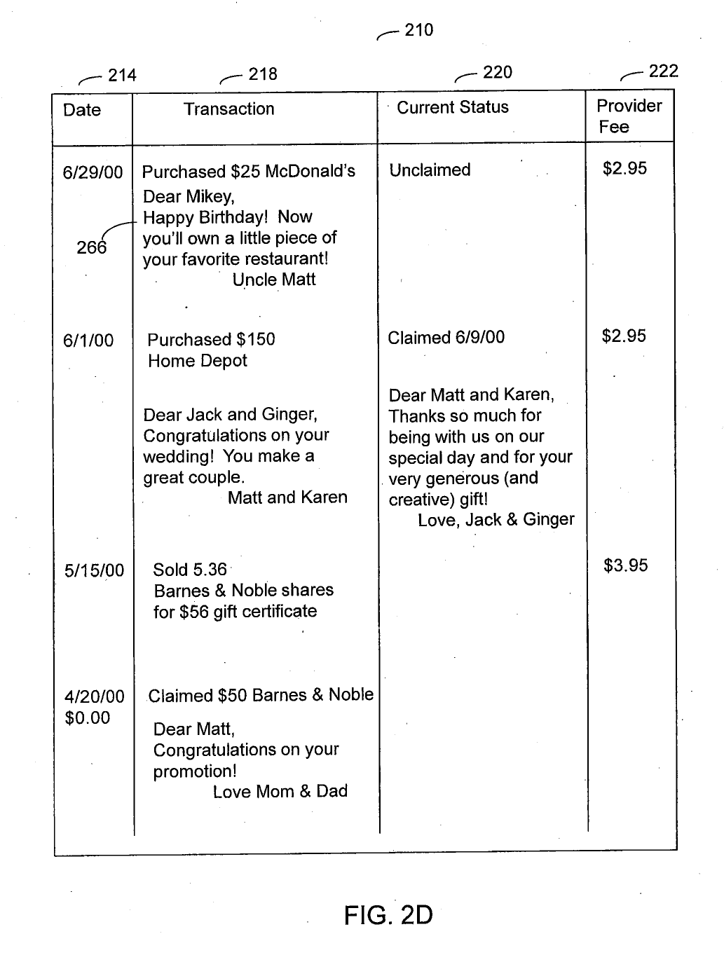

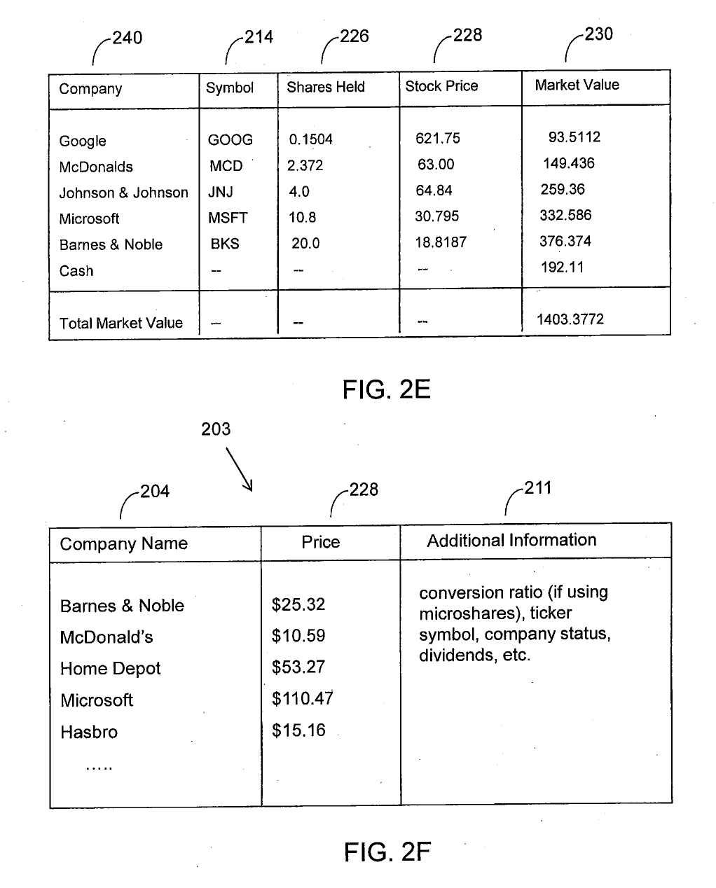

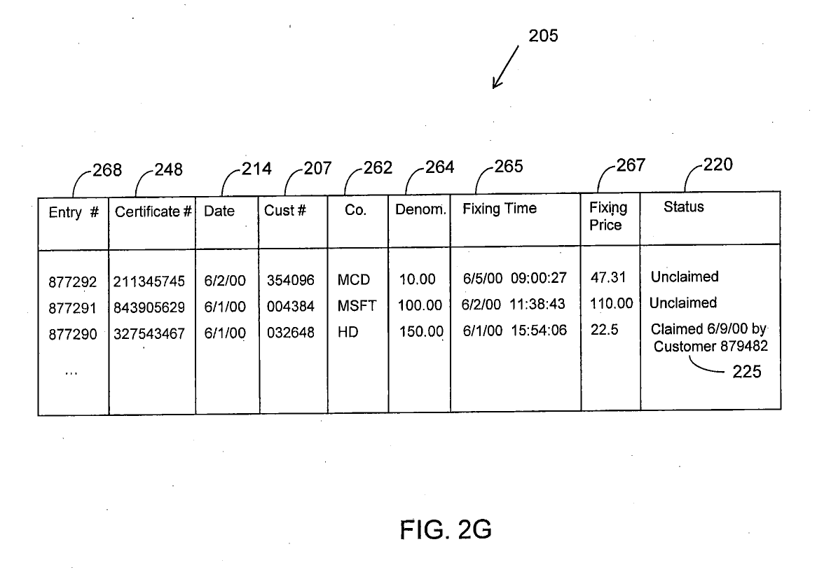

Referring to FIGS. 2A to 2G, provider database 134 may store various kinds of information. This may include information about (a) customers 110 who have registered with the provider, (b) companies whose stock may be given in the form of a gift certificate (to the extent the system implementation limits the companies whose stock may be purchased), and (c) gift certificates that have been issued by the provider.

As shown in FIG. 2A, a list 202 of all registered customers may be stored, along with links to more detailed information for each customer that may include, as shown in FIG. 2B:
206: customer identification and contact information (e.g., customer number, name, address, phone, email address, account number, login name and password, social security number, etc.) as shown in greater detail in FIG. 2C;
208: customer demographic and preference information (e.g., age, sex, marital and family status, education, occupation, suitability information, interests, preferences regarding desire to receive advertising and promotions, etc.), as shown in greater detail in FIG. 2C;
210: customer transaction history, including, as shown in greater detail in FIG. 2D, a list of gift certificates purchased and claimed, and shares bought or sold, with transaction date 214, description 218, current status 220, and provider fee 222, if any, for each transaction;
212: customer account summary including, as shown in greater detail in FIG. 2E, list of all companies 240 in which shares are held, the number of shares 226 held for each company, current market price for one publicly traded share 228, market value of shares held 230, etc. Optionally, if the numbers of shares are rational numbers, it may be convenient to refer to the number of “microshares” that corresponds to a particular number of shares. For example, if 2.345 shares are held, it may be convenient to refer to that amount as being equivalent to 2,345 microshares, where a conversion ratio (in this example, 0.001) or its reciprocal establishes the relationship between the numbers of microshares and shares,

Some of the information is specified by the customer or assigned by the system during initial registration, while other information is recorded after transactions at the provider's website, or computed using other information in the database and/or external data sources.

Also stored in database 134 is a list 203 of companies whose stock may be purchased and given in the form of a gift certificate, and possibly additional information 211 about each company (see FIG. 2F). These companies could include every publicly traded stock, or may include a subset of companies that may be chosen for participation based on a number of criteria that may include whether their stock is one that is popular or widely held by the investing public, whether they have paid a listing fee to the provider, the price or volatility of the stock in the public markets, etc. Some or all of the companies 204 may, but need not, utilize a conversion ratio (to the extent conversion ratios and/or microshares are used in implementing the invention).

As shown in FIG. 2G, database 134 also may include a list 205 of gift certificates that have been issued by provider 130. Each entry in list 205 may include an entry number 268, gift certificate identifier 248, date of purchase 214, information sufficient to identify the purchaser 207 and (if the certificate has been claimed) recipient 225 (which might consist of some or all of information 206 shown in FIG. 2B), the name of the company or stock symbol 262 whose stock was gifted, gift certificate denomination 264, fixing time 265, fixing price 267, and current status 220 of the certificate (e.g., “outstanding but unclaimed,” “claimed,” “redeemed for cash,” etc.).

Various portions of the database 134 may be viewed by registered customers. For example, customers may view certain details regarding their own identification, demographic, transaction, and account information 206-212. Such queries may take place at the provider website via, e.g., user-friendly interfaces that include form fields, radio buttons, checkboxes, and drop down menus. Ways in which the information in database 134 may be accessed, updated, and queried are described below. Other portions of the database, such as the list 203 of companies, may be viewed by non-registered and registered customers.

The foregoing description of database 134 is merely illustrative, and a person skilled in the art will appreciate that there are many other ways of obtaining and organizing the information, and that additional or other types of information could be used.

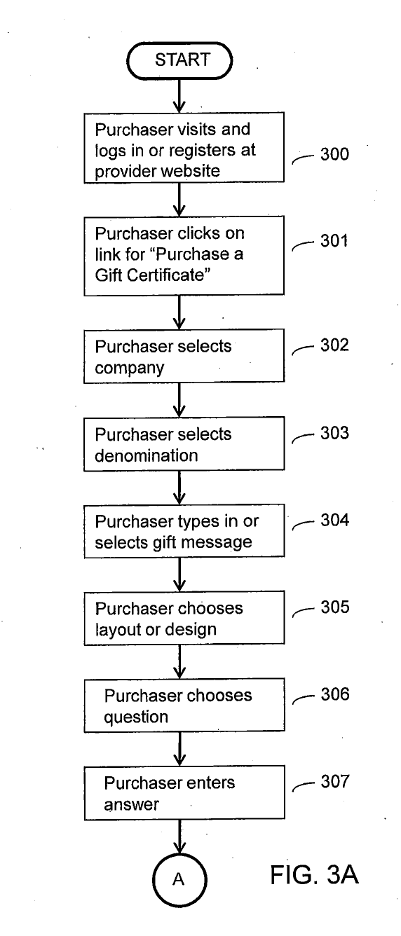

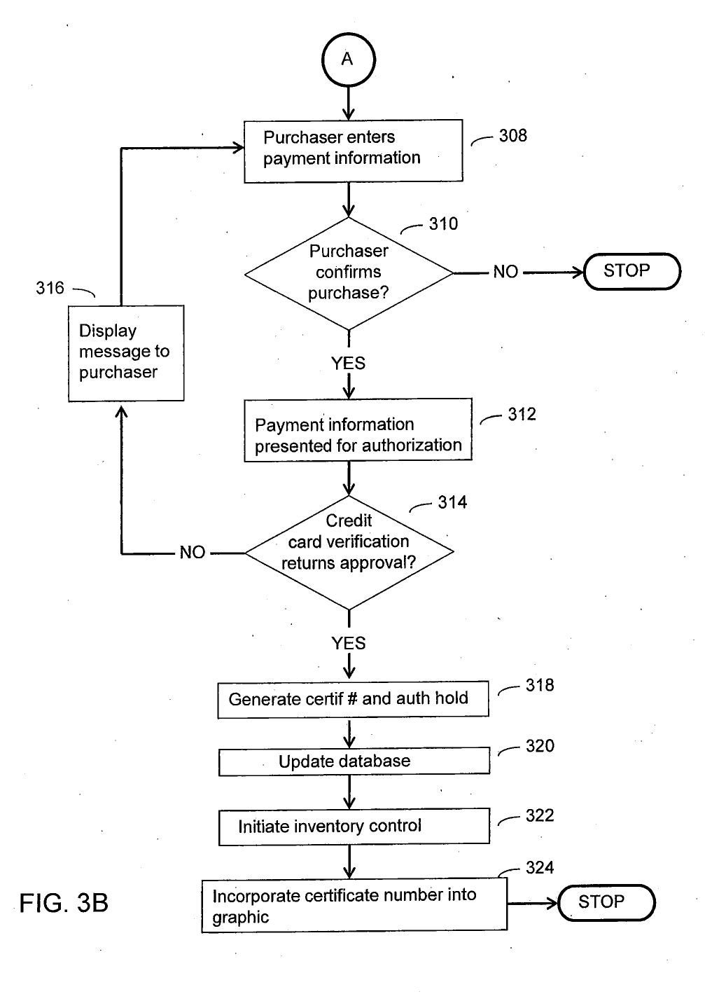

A process for purchasing a gift certificate is now described in connection with the flowchart of FIG. 3A. The purchaser may be asked in step 300 either (a) to enter a customer ID and password, so that the member's account and other information may be accessed; or (b) if not a member, to register. Alternatively, and to avoid deterring purchases of gift certificates, a non-member may be given an option to provide only limited information (e.g., payment information) without having to establish a membership account. Or, if applicable regulations or laws require the purchaser to have an account until the gift certificate is claimed, the purchaser may be given the option to close the account upon claiming of the gift certificate by the recipient. Another possibility may be to preauthorize a purchase but wait to transfer funds until the gift certificate is claimed.

As with many steps that are described in the purchasing process (as well as other processes described in the present disclosure), every step need not occur in the order described. For example, the step of logging in, registering, or providing more limited information need not take place at the beginning of the purchasing process, but instead could be deferred until later, e.g., once the purchaser has made certain selections (e.g., name of company, gift certificate face value, etc.).

In steps 301 and 302, purchaser 110 selects the link on the provider website labeled “Purchase a Gift Certificate,” and a company 262 whose stock he wishes to give in the form of a gift certificate. Company 262 may be chosen, e.g., from a list 203 by using a drop down menu, by entering the company's name or ticker symbol, or by using a search tool (e.g., that returns names of companies that sell a particular kind of product or the company that sells a particular brand). The companies may be displayed in a variety of ways based on how the purchaser wishes to view them, e.g., alphabetically, by category (e.g., “cars,” “clothing,” “food & drink,” “sports,” etc.), by age group/sex (e.g., “babies,” “boys,” “girls,” “teens,” “moms,” etc.), by occasion/holiday (e.g., “Christmas,” “graduation,” “wedding,” etc.), or by popularity (e.g., “top 10 all time”).

The purchaser in step 303 also may select a dollar amount 264 for the gift certificate (e.g., $50, $17.25, etc.) by entering an amount in dollars and cents, selecting an amount using a dropdown, or in other ways. The selected denomination 264, together with the market value or “fixing price” 267 of company 262's publicly traded stock as of a certain “fixing time” 265, determines or “fixes” the number of shares of stock that are being gifted. (For example, if the gift certificate is for $25 worth of Company A stock, and Company A stock as of the fixing time 265 is trading at a fixing price 267 of $125/share, then the number of shares is fixed at 0.2.) Alternatively, the purchaser could specify the number of shares (e.g., 0.2) instead of denomination 264. In this case, the dollar amount charged to the purchaser depends on the number of shares purchased and the market value of the publicly traded stock at the fixing time 265.

The fixing time 265 may occur at any of various points in time and, e.g., may be keyed to when the gift certificate is purchased or claimed. For example, the fixing time may be the earliest time after the purchase or claim is made that the public markets are open, or at the next market close. Or it may be at or near the time the purchase or claim is made (“real time”). If the public markets are closed at the time, the fixing price 267 could be the price of the stock at the previous market close, an after-hours quote, or some other price. Or, the fixing time 265 may be at the next predefined time relative to the date of the purchase or claim (e.g., at the next market close, noon on the next trading day, 10 am on the next Tuesday), or at some other time (e.g., the date of the occasion for which the gift is being given, or some other date/time specified by the purchaser or recipient).

Next, in step 304, purchaser 110 may type in a gift message 266 that may identify the purchaser and the occasion. If desired, the purchaser may select from a list of form messages to avoid having to think of a message, or may use a form message as a starting point to edit and tailor to fit the occasion. In step 305, the purchaser optionally may choose from a number of layouts and graphic designs for the gift certificate. Layouts might include portrait landscape, etc. Graphic designs might include background graphics (e.g., balloons for a birthday, wedding bells for a wedding, Christmas trees and candy canes for a Christmas present), border graphics (traditional contemporary, etc.), colors, fonts, type sizes, etc., or custom graphics or web images uploaded or downloaded by purchaser 110.

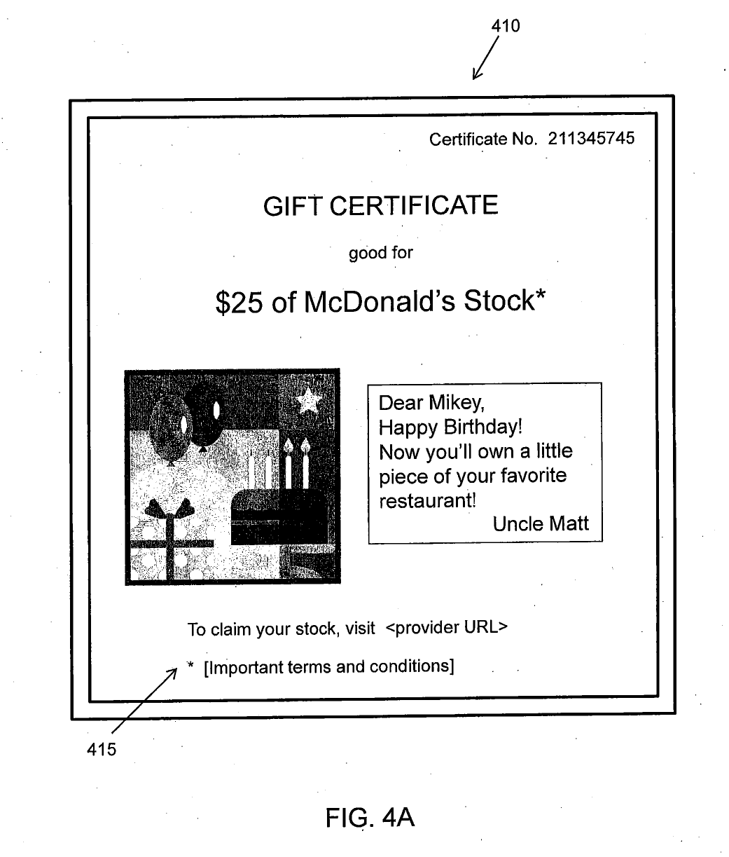

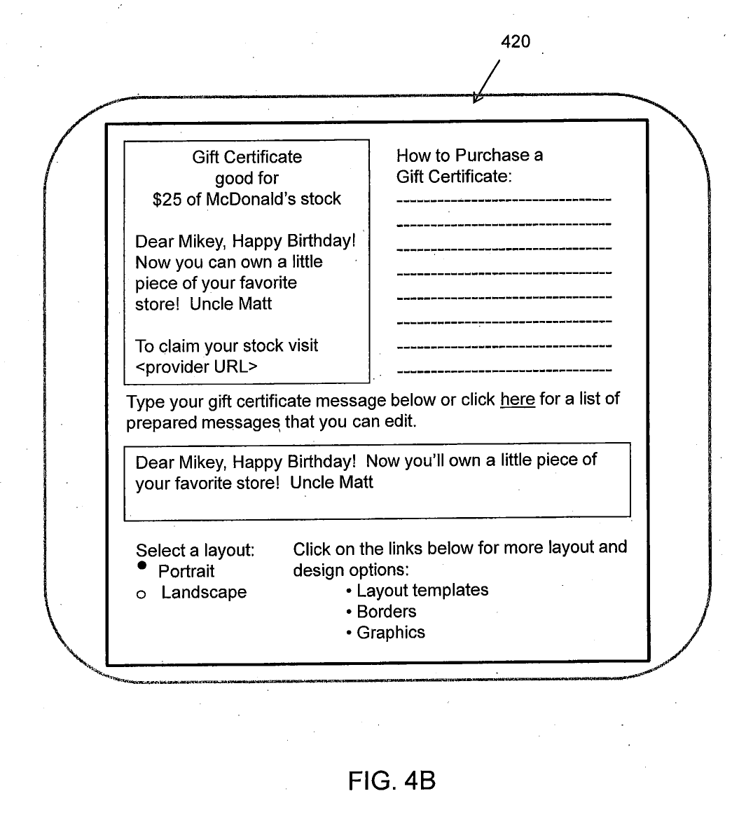

As the purchaser enters information in steps 300 to 305, a what-you-see-is-what-you-get (“wysiwyg”) graphic, as illustrated in FIG. 4A, may be generated and displayed on the purchaser's screen display. That is, as illustrated in FIG. 4B, the gift certificate may be built as the purchaser enters information at the webpage. This wysiwyg approach enables the purchaser to interactively and adaptively specify and re-specify part or all of the information requested in steps 300-305 until the contents and format of the gift certificate are as desired. Additionally, the purchaser may print or print-preview the screen contents, to see how the gift certificate will look when printed.

The purchaser also may specify how much information the recipient will need to enter to claim the gift certificate. For example, the purchaser may choose to make the gift certificate claimable simply upon entering certain information appearing on the gift certificate (e.g., the gift certificate identifier 248 and/or denomination 264). In this case, anyone who has physical possession of the gift certificate can claim it. That is, the recipient need not be identified by the purchaser, and need not even be known to the purchaser.

Alternatively, the purchaser may choose to make the gift certificate claimable only if information not appearing on the gift certificate is entered in lieu of, or in addition to, information that does appear on the gift certificate. Requiring the recipient to enter information that does not appear on the gift certificate provides a form of protection against the circumstance where the gift certificate may have been lost or stolen before it has been claimed by the recipient.

For example, in addition to a gift identifier, the purchaser may require that the recipient's cell phone number, birth date, a password, or some other claiming information known to the purchaser and recipient should be entered by the recipient when claiming the stock. The purchaser may also specify a question for which the recipient will know the answer but a randomly selected member of the public likely will not. In step 306, the purchaser may choose from a list of such questions to be posed to the recipient at the time of claiming (e.g., “What is the name of your dog?” or “What school do we both go to?” or “What is your home phone number?”), or make up his or her own question. The purchaser then enters the answer to the question in step 307.

Thus, of the information that is required to claim a gift certificate (hereafter referred to as the gift certificate claiming information), part or all of it may appear on the gift certificate. The gift certificate identifier 248, which uniquely identifies the gift of stock, typically will be part of the gift certificate claiming information.

Next, in step 308, the purchaser is prompted to enter payment information 246, such as credit card number and expiration date, cardholder name and billing address (for address verification during credit card processing), the 3- or 4-digit security code printed on the card, etc., or information for another payment service such as PayPal™. Alternatively, the purchaser may opt to pay for the certificate using cash through an electronic funds transfer, debit card, cash card, conventional gift card, or other stored value or prepaid card; using stock or some other asset in an account held with the provider; or in some other way.

Commissions/fees charged by the provider may affect the face value or number of shares associated with the gift certificate, or the purchase price of the gift certificate. For example, if the purchaser chooses to buy a $25 gift certificate of Company A stock, he or she may be charged a $2 fee by the provider, making the total purchase price $27. Alternatively, the $2 fee may be assessed to the claimant upon redemption, in which case the claimant might receive $23 worth of Company A stock, or the full $25 worth by paying a $2 claiming fee. Likewise, if the purchaser chooses to buy a gift certificate redeemable for 0.5 shares of Company A's stock, commissions/fees may make the purchase price higher than half of the market value of one share of publicly traded stock or may net the claimant less than half a share of stock.

If the purchaser confirms the purchase (step 310), the provider in step 312 may present the payment information 242 to a third-party payment processor for authorization. If authorization is unsuccessful (as tested in step 314), an error message may be sent to the purchaser in step 316. Otherwise, in step 318, an authorization hold for the total purchase price (gift certificate denomination plus any commissions and fees) may be placed on the purchaser's account, and a gift certificate identifier may be generated using, e.g., a pseudorandom number generator or other algorithm.

The number generator should be designed to produce gift certificate identifiers that have a sufficient number of digits and are sufficiently hard to predict given knowledge of other valid certificate identifiers. That is, a random attempt to guess a valid identifier should fail with sufficiently high probability. Additionally, it might be preferable to choose the length or other format of the certificate identifiers so as to facilitate other processing. For example, a sixteen digit number may be useful for easier integration into an existing credit or debit card infrastructure. Also, it is noted that certificate identifier 248 need not be purely numeric. Its digits may consist of or include letters of an alphabet and/or other characters or symbols.

Once the gift certificate identifier 248 has been generated, transaction history 210 in database 134 and gift certificate list 205 in FIG. 2G may be updated in step 320 with the certificate identifier 248 and claiming information together with other pertinent information. The gift certificate identifier 248 then may be incorporated into the graphic in step 324. (Optionally, step 324 might also include incorporating a bar code or other representation of identifier 248 and possibly other information, such as company 262 and denomination 264, to facilitate the process of claiming the gift certificate as described below in Section 4.) The gift certificate might read “Good for $25 Worth of Company A Stock,” possibly with an “asterisk” 415 specifying certain conditions associated with the transaction (e.g., that the stock chosen by the purchaser is only a suggestion, that any other stock in list 203 may be chosen by the recipient, that the exact number of shares will be based on the market value as of a particular time (the fixing time 265), that certain fees will be assessed for inactive recipient accounts, that all statements and confirms will be electronic, etc.).

At this point, the gift certificate may be emailed by purchaser 110 (or by provider 130 on behalf of the purchaser) to recipient 120 at recipient's email address as specified by the purchaser by typing it into a form field, selecting it from an address book, etc. The email may include gift certificate identifier 248, name of company 262, denomination 264, optional gift message 266, and other information. The graphic incorporating this information, or simply the information itself, could be emailed. Alternatively or additionally, the gift certificate may be printed by the purchaser using a conventional printer on conventional paper, a commercial greeting card, etc., or printed out and mailed to the recipient by the provider. As yet another alternative, the purchaser could convey to the recipient any or all of the claiming information (e.g., certificate number 248, company 262, and denomination 264) in other ways, e.g., verbally or by writing it on a conventional greeting card. The purchaser may be given the opportunity to select from among these or other alternatives.

Although the above description is in the context of a single gift certificate being purchased, the system could be implemented to enable the purchase of more than one gift certificate at a time. For example, the purchaser could choose a company name and dollar amount for each of a number of recipients, and then pay for the gift certificates in the shopping cart with one credit card transaction.

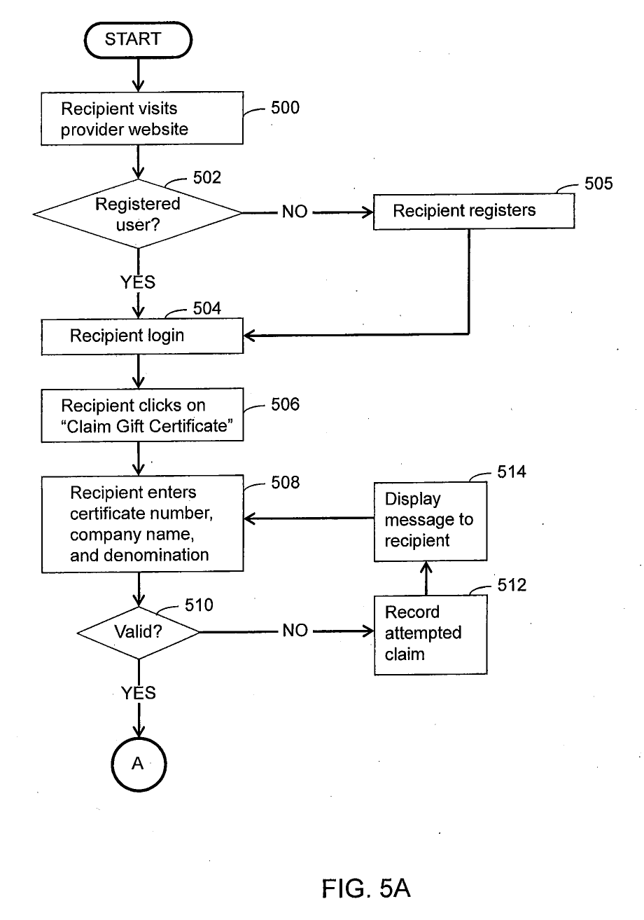

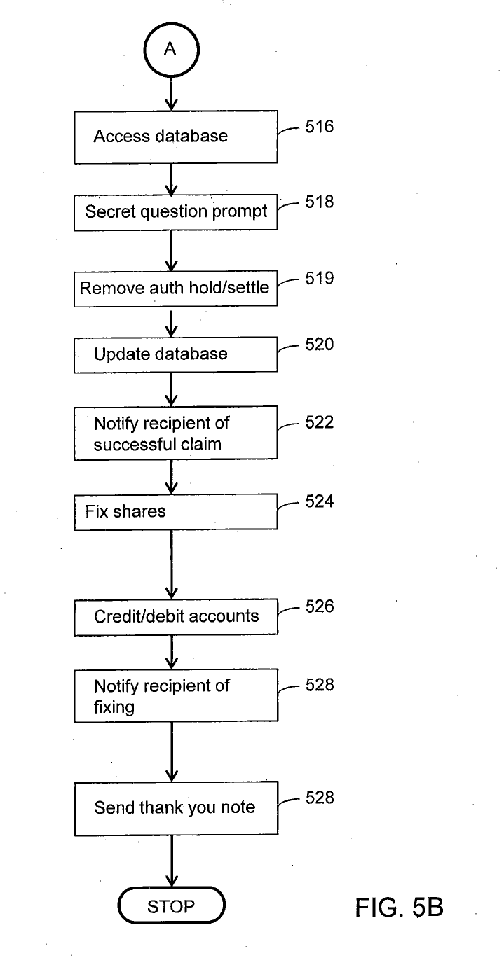

A process by which a recipient 120 may claim stock associated with a gift certificate is now described in connection with the flowchart of FIG. 5. Once she is at provider website (step 500), if the recipient is a registered user (as tested in step 502), she logs in by entering a customer ID and password in step 504, so that her account and other information may be accessed. If she is not a member, she may be required to register (step 505). Requiring the recipient to register as a member before claiming may promote increases in the provider's membership. However, it may be preferable not to require the recipient to provide more information than is needed at the time of claiming (e.g., information that may not be needed until shares are sold) to avoid deterring the recipient from registering. It also may be desirable to defer registration of the recipient until after she has entered the information needed to claim the stock (e.g., after step 526).

In step 506, the recipient clicks on the link labeled “Claim Gift Certificate,” and then in step 508 enters the gift certificate identifier 248, and enters, selects, or otherwise designates possibly other claiming information such as the company name 262 (or associated ticker symbol) and denomination 264 printed on the gift certificate. (If any or all of this information is represented on the gift certificate in barcode format, the recipient may use a barcode reader in lieu of entering the information manually. Other interfaces that facilitate the entry of information also may be used.)

Provider 130 then compares the entered information with that stored in its database 205. If there is a match, as tested in step 510, the gift certificate may be determined to be valid. If not, the attempted claim may be recorded in step 512, and an error message may be displayed in step 514 inviting the recipient to enter the correct information. Further actions, such as disabling additional claim attempts, also may be taken in step 512 if, for example, invalid information has been entered a certain number of times. Database 205 then is accessed to determine (step 516) if the purchaser invoked a fraud protection feature. If so, the recipient is asked in step 518 to answer the secret question posed by the purchaser.

The unpredictability of valid certificate identifiers (e.g., given knowledge of other valid certificate identifiers) makes it highly unlikely for someone to claim a valid gift certificate by randomly picking a number or character string and entering it into the system. This is especially true since the system may monitor and record unsuccessful claim attempts (in step 512), and only registered users are permitted access to the webpage where claims are made (step 504). This unlikely possibility, however, is made even more remote by requiring the recipient to enter additional claiming information, such as the company name 262 and denomination 264, in step 508. Now, a third party attempting to defraud the provider would not only have to guess a valid certificate identifier, but also the company name and denomination that go with it.

Finally, the fraud protection feature, whereby a portion of the gift certificate claiming information is not printed on and does not otherwise appear on the gift certificate, greatly reduces the possibility that someone will be able to claim a lost or stolen gift certificate. For example, because the answer to question is not printed on gift certificate, a thief or finder will not be able to successfully advance past step 520. Unsuccessful attempts may be recorded, and one or more messages may be sent or displayed to the purchaser, attempted recipient, and/or intended recipient. Further action also may be taken to disable additional attempts.

If the recipient successfully enters all required information, in step 519, the authorization hold on the purchaser's credit card is removed and the credit card transaction is settled, so that the funds may be applied to the purchase of stock for the recipient, as well as to any commissions or fees charged by the provider. Database 205 may be updated in step 520 to reflect that the gift certificate 160 has been successfully claimed. The recipient in step 522 then may be notified that the gift certificate was successfully claimed, and may be given an option to choose a stock other than the one selected by the purchaser or even some other asset (e.g., mutual fund shares) or item other than stock (e.g., a conventional merchandise gift card) that is offered by the provider.

Once the provider fixes the number of shares (step 524), the recipient's account may be credited with the appropriate number of shares, and another account (e.g., the provider's inventory account) may be correspondingly debited by the same number of shares (step 526), and the recipient may be notified in step 528 that fixing has occurred. The number of shares that are credited to the recipient's account may be a non-integer number.

At the time of claiming, the recipient optionally could be given control over the fixing time or fixing price. For example, the recipient could choose a later fixing time if she expects a decline in the market price of the chosen stock. As another example, she might be allowed to place a “limit order, good 'til canceled” if she wants to delay fixing until the share price falls below a certain level.

At the time the gift certificate is claimed, the recipient also might be asked if she wishes to send a thank you note to the purchaser. If the recipient so desires, she may enter a thank you message in a form field or select and edit one of several template messages. The message is then delivered to the purchaser, e.g., by email (step 530).

In addition, the provider optionally might send an email to the purchaser for a variety of reasons (e.g., to thank him for his purchase, notify him that the gift certificate has been claimed, notify him that it still has not been claimed, give him an opportunity to resend the gift certificate or revoke it and take back its value, etc.).

The fractional shares of stock held by provider's customers may be covered by integer shares that are bought and sold by the provider. The provider may cover the fractional holdings of its customers by maintaining an inventory of integer shares, and assigning fractional shares from this inventory to a customer, e.g., when a gift certificate is claimed, or transferring fractional shares from a customer to its inventory, e.g., when a customer sells some stock.

For regulatory, risk management, or other purposes, the provider may wish to monitor and control its inventory 209 (see FIG. 2A), i.e., the number of publicly traded shares that it owns in each company in which the provider's customers may own shares or that are available for selection by a purchaser. This may be done by monitoring the aggregate number of shares owned by customers and the number of publicly traded shares held by the provider, and buying or selling shares on the open market (or some other way, such as directly to or from the company) as appropriate.

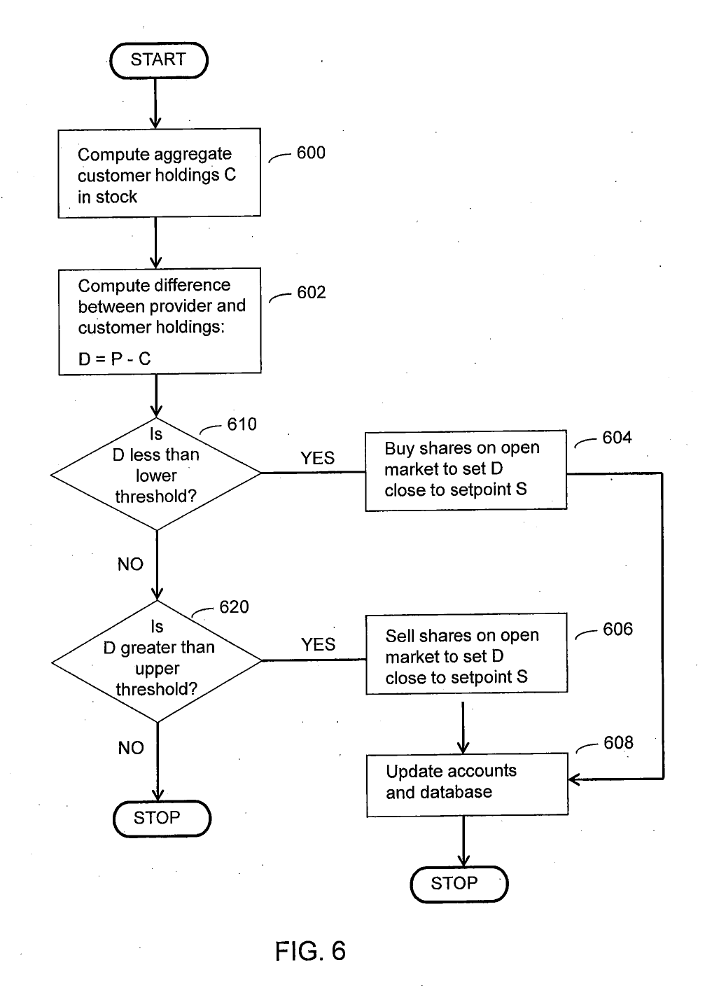

For each company, inventory control may be accomplished in accordance with a process such as that shown in FIG. 6. After stock in the company has been claimed by a customer who is a gift certificate recipient (or bought or sold by a customer for his own account outside of the context of a gift certificate), in step 600, a computation may be done to compute the aggregate number of publicly traded shares, C, that will be held by customers after the current purchase/redemption request is completed. This may be done by adding together the number of shares held by each customer to find the total number of shares C. Then, in step 602, the number of shares currently held by the provider, P, is determined from the database 209, and the difference, D, between the holdings by the provider and the number of shares to be held by customers is computed as D=P−C.

This difference D is compared in step 610 with a lower threshold T_{L}. This lower threshold may be selected by the provider based on regulatory requirements, risk management preferences, and other factors. If D<T_{L}, as tested in step 610, the provider buys shares on the open market so that after the purchase, the difference D will be non-negative and sufficiently close to, or a desired distance away from, a set point S (step 604). The set point S also may be selected by the provider based on regulatory, risk management, and other factors. Then, in step 608, the provider database 209 and accounts are updated to record the transaction and reflect the change in holdings.

If D is not less than T_{L}, as tested in step 610, then another test is made in step 620 to see if D is greater than some upper threshold T_{U}. As with T_{L} and S, the choice of T_{U} may be made based on various regulatory, risk management and other factors. If D>T_{U}, the provider may sell shares on the open market such that D is non-negative and sufficiently close to, or a desired distance away from, set point S (step 606). In step 608, the provider database 208 and accounts are updated to record the transaction and reflect the change in holdings.

If D is not greater than T_{U} as tested in step 620, then D is within acceptable bounds and it may be determined that no shares need to be bought or sold on the open market.

The parameters T_{L}, T_{U}, and S may be different for each company in which customers and the provider hold shares. In addition to depending on regulatory requirements and risk management preferences, these parameters may depend on properties of the company and/or its stock price (e.g., stock price volatility, the company's industry group, whether the company is a recent issue, etc.), the balance sheet and other holdings of the provider (e.g., the amount of cash held, cash flow, amount of other stocks held, etc.), economic conditions (e.g., prevailing interest rates, etc.), or other factors.

For example, if it is the policy of the provider always to have all positions covered, then T_{L} may be set equal to zero. A check is made in step 610 to see if enough shares of the company's stock are currently in the provider's inventory 209 so as to cover the shares being purchased by purchaser 110 (i.e., D may be compared to 0).

Another alternative for inventory control is to make sure that after allocating shares to customers, the dollar value of the inventory held by the provider for a given stock is in a specified range between D_{L} and D_{U}. If customer claims would make the dollar value of the inventory fall outside of this range, then the provider can buy or sell shares on the open market to bring the inventory after fulfilling the customer claims within the range D_{L} to D_{U}. As before, the parameters D_{L} to D_{U} may depend on regulatory, risk management, or other factors. Also, the parameters may be different for each stock.

Other alternatives for inventory control are also possible. For example, individual buy and sell orders may be pooled or offset to reduce the number of trades on the open markets. This aggregation may take place periodically (e.g., daily). Likewise, buying and selling derivatives or futures contracts may be employed for hedging purposes.

A customer may use the provider's system to view his or her account information. This may include, for example, the customer's personal information and account holdings 212 (see FIG. 2E), where the latter might include the number of shares held 226 and/or their current market value 230. One or more of these items may be emphasized in different “views” of the account—e.g., a “dollar view” might emphasize how much of each stock a customer owns in dollars, whereas a “share view” might emphasize how much is owned in terms of number of shares.

The customer may click on additional links to view additional information, such as a display of the gift history 210 shown in FIG. 2D. The gift history 210 may include a list of gift certificates purchased by the customer for others and/or received by the customer from others. A list entry that corresponds to a gift purchased for someone else may include the date 214 of purchase, gift message, company, denomination, and possibly other information, such as when and by whom the certificate was claimed. Likewise, an entry for a gift that was received and claimed may include the date 214 the certificate was claimed, gift message, company, denomination, and possibly other information, such as who gave the certificate.

The gift certificate is described above as being associated with gift certificate claiming information (which includes, e.g., a gift certificate identifier) that the recipient enters in order to claim the stock associated with a gift certificate. In another embodiment, the gift certificate may include an identifier in the form of a link to a webpage where the gift certificate may be claimed. Upon receiving from the purchaser the name of the company, denomination, payment information, etc., the provider system creates a link that is specific to the particular gift certificate being purchased. The link may be encrypted to promote security and prevent fraud. The system adds the link to the email that includes the gift certificate, and may in fact embed the link within part or all of the gift certificate image. The purchaser also provides information identifying a recipient, such as the recipient's email address or brokerage account information. The system uses this information to send the gift certificate to the recipient, thereby notifying the recipient of the stock and dollar amount being gifted and the associated identifier. Upon receiving the gift certificate, the recipient may make a request to claim the gift by clicking on the link, which results in displaying to the recipient to a webpage where the associated stock may be claimed. An appropriate amount of stock may be credited to the recipient once she provides account information, e.g., by logging in to her existing provider account or opening a new provider account, and provides any other claiming information (e.g., enters her phone number or answers a fraud protection question) that is required. Thereafter, the correct amount of stock may be purchased and credited to the recipient's account as described above. This alternate embodiment enables the claiming of stock by clicking on a link in the email instead of having to enter an identifier that might be a relatively long string of numbers.

In another embodiment, the purchaser could be given the option of selecting more than one company (or even all of the companies listed), thereby creating and giving what may be referred to as a “Flexertificate™”. As a more specific example, the purchaser could select Companies A, B, and C from the list 203 of all companies whose shares may be purchased, along with an overall dollar amount 264 for the certificate. The names of these three companies may appear on the gift certificate 260, or some text may be placed on the certificate indicating where a list of the companies may be viewed. The recipient may choose one, two, or all three companies and specify an allocation of the dollar amount 264 over the chosen companies, after which his or her provider account may be credited with an appropriate number of shares for those one or more companies.

Alternatively, the purchaser could specify the allocation of the dollar amount over the designated companies, e.g., a gift certificate redeemable for $10 of Company A stock, $20 of Company B stock, and $20 of Company C stock. This enables the purchaser to give a gift certificate redeemable for a portfolio of stock that the purchaser has assembled. The Flexertificate™ thus provides flexibility while still reflecting the purchaser's creativity and thoughtfulness in selecting the companies designated on the gift certificate.

Another feature may provide the purchaser with a reminder to make a similar purchase in successive years. For this purpose, database 134 may be augmented to include a descriptor that describes the event for which the gift was given: e.g., a birthday, anniversary, birth of a new baby, or graduation, where the first three examples indicate a recurring event and the last a one-time event. Periodically, the provider system accesses database 134 to determine which gifts have a descriptor corresponding to a recurring event and were purchased about a year ago (or a month ago, or some other duration of time).

For such gifts, the purchaser's email address could be accessed from database 134, and an email could be sent to the purchaser reminding the purchaser that he or she purchased a gift for the recipient last year, and prompting the purchaser to do the same this year. (Alternatively, the notification could occur in ways other than through email.) This alleviates the risk that a purchaser might forget the same birthday the following year, and also generates repeat business for the provider. At the time a gift certificate is purchased, the purchaser could be given the option to receive a reminder the following year. Indeed, the purchaser also could be given an option whereby, each year, a gift of stock is given (and the purchaser's credit card is charged) automatically.

Along the same lines, the purchaser could be given the option to pre-designate gift certificates for one or more occasions ahead of time. For example, a purchaser might sit down once, at the beginning of the year, and select gift certificates for several birthdays and other occasions that will occur during that year. Provider 130 could automatically email or mail the gift certificate just before the date of each designated occasion. The purchaser's credit card could be charged once at the beginning of the year for all purchases, or separately at the time of each occasion.

Further, the system could maintain or access a calendar for the purchaser, and alert the purchaser to upcoming dates of interest. For example, a preference could be set to alert the purchaser three days before the birthday of a friend or family member.

In yet another embodiment of the invention, a gift registry may be implemented. A recipient may identify stocks, commodities, or other asset classes that are desired to be received, or may choose to identify nothing but his or her desire to receive any available gift. The recipient further may optionally identify an event or occasion (such as a wedding, birthday, Bar or Bat Mitzvah, Communion, or graduation) that is to be identified with the registry. Thereafter, the recipient may notify potential purchasers of the registry, which may also be located by searching at the provider's website. Potential purchasers may then choose to purchase and give desired amounts of gifts that the recipient has identified (e.g., Purchaser 1 may choose to give $100 of Company A stock, Purchaser 2 may choose to give a $200 Flexertificate™ good for any stock or asset the recipient has identified, and Purchaser 3 may choose to give $75 worth of gold).

At the option of the gift registry recipient, the system may display a current status of gifts that have been purchased, e.g., to show the particular stocks or other assets that have been purchased, with or without the cumulative amount of each asset. Fixing may occur at the time of purchase, at the time of claiming, or at some time in between. Indeed, the registry may be set up so as not to require claiming by the recipient. In this case, the stock or other asset associated with a gift would be direct deposited into the recipient's provider account. As with other features and embodiments of the invention, the gift registry may be implemented in conjunction with other features and embodiments discussed herein, e.g., with an interface to a wedding registry website, a party or event invitation website, or a social networking website.

A purchaser also could be given the option to “direct deposit” stock into a recipient's account, thereby eliminating any need for the recipient to claim the shares. (This option could be advantageous where the recipient already has an account (which the purchaser might know in advance or could look up through the system), or where the purchaser wishes to purchase stock for himself or herself.)

Additionally, shares already owned by one customer may be obtained from that customer's account and gifted to another customer without selling the shares for cash and then purchasing a gift certificate. For example, if a customer owns 2.41 shares of Company A that are worth $87.65, the customer may give $50 of that stock in the form of a gift certificate redeemable for $50 of Company A's stock (or even some other stock, through a streamlined redemption process) to a recipient, leaving the customer with $37.65 worth of the stock. (Some or all of these amounts may be subject to commissions/fees.)

Further, at the time of purchase, value could be added to the certificate, or the cost to the purchaser could be reduced, in exchange for the purchaser's providing other information (e.g., filling out a survey) or taking other action (e.g., purchasing a third party's product or service). For example, when a customer is purchasing a $50 gift certificate, a third party might offer to contribute $10, thereby increasing the value of the certificate to $60, or lower its cost to the purchaser to only $40, in exchange for the customer's completing a short survey. Value could be added to the certificate in similar ways during claiming or redemption.

The applicability of the present disclosure need not be limited to gifts of stock. Other securities, financial instruments, and asset classes could be used in a similar manner. For example, instead of shares in a single stock, one could use shares in a group (or index) of stocks or a mutual fund. Commodities could be used as well. For example, a purchaser could purchase a gift certificate redeemable for $10 worth of gold. Bonds and options are other examples. In the case of bonds, a purchaser could purchase a gift certificate redeemable for a specified dollar amount of a bond having a specified face value, coupon, and maturity date. In the case of options, a purchaser could purchase an option on an underlying dollar amount (or non-integer number of shares) of stock, or a specified dollar amount's worth of a publicly traded option. As with conventional stock options, a strike price and expiration date for the option may be specified.

The system and method of the present disclosure for transferring securities to be claimed by a recipient, also could be applied to securities such as stocks, bonds, mutual funds, and options in conventional (non-fractional) amounts. This would avoid the current cumbersome process that is used to transfer securities from one individual to another.

In another embodiment, a gift certificate could be used to directly transfer shares between accounts held at two different brokerage firms. The two brokerages could be equipped to handle the gift certificate transactions directly with each other or the provider could serve as an intermediary between the two brokerages.

In still another embodiment of the invention, customers could purchase gift certificates of shares of a company's stock directly from the company 262, with provider 130 playing a different role than that described above (e.g., an accounting and/or redemption role in which customers could view their holdings for all companies at provider website 132 and/or place redemption orders with provider 130).

In another embodiment, a third party broker could handle the aspects of the invention relating to trading and holding shares. For example, the provider could operate as an introducing broker, with a third party operating as a clearing broker to execute trades, act as custodian, issue statements and confirms, and perform other functions. The provider could operate on a fully-disclosed or omnibus basis.

In yet another embodiment, there may not be a separate provider. Instead, a company could play the roles of both company and provider 130. In this case, the company would offer gift certificates for, maintain database records of, and process claims of gift certificates and redemption orders for, shares of its own stock.

Although the invention has been described in the context of gift certificates, gift cards could be used instead. A blank gift card could be purchased and activated at the point of sale using a barcode scanner, with the gift certificate identifier provided to the purchaser separately or on the gift card itself (e.g., covered by a coating that may be scratched to reveal the identifier). The purchaser could then log on to the provider's website and enter the gift certificate identifier and other claiming information (e.g., a company name and denomination), charge the face value and any associated fees to a credit card, and give the recipient the gift card and claiming information, which the recipient could use to claim the associated stock. The fixing of the number of shares/dollar amount could take place at the time of purchase, at the time of claiming, or some other time. Or, gift cards with specified dollar amounts (e.g., $10, $25, $50, $100 of Company A's stock or any participating company's stock) or specified numbers of shares (e.g., ¼, ½, 1, 2 shares of Company A's stock) could be made available at a point of sale in a retail location. (Alternatively, the purchaser could specify the desired dollar amount or number of shares, which could be incorporated into a blank gift card at the point of sale.)

Likewise, although the invention has been described in the context of shares that are owned by the provider's customers, it may be desirable (e.g., for regulatory or implementation purposes) for the customers instead to own the cash equivalent of the shares, or a contractual entitlement to the shares or their cash equivalent. For example, a customer may own the cash equivalent of 0.25 shares of Company A's stock, which cash equivalent could fluctuate according to the market value of that stock.

It may be desirable to some purchasers to have certain information about the gift certificate not known to the claimant (or potentially even the purchaser) until the time of claiming. For example, the purchaser may wish for the dollar amount, number of shares, or identity of the asset (e.g., that it is Company A or an oil futures contract) to remain a surprise until the time of claiming. Similarly, the purchaser may wish for the identity of the asset to be generated at the time of claiming. In this case, this information would not appear on the gift certificate, and the system could be implemented to highlight or otherwise emphasize the hidden information when it is finally revealed to the claimant.

In the embodiments described in connection with the figures, gift certificates have been described as being purchased by one person to be given to another person. However, their use is not so restricted. A merchant may purchase what is referred to herein as a “gift certificate” and award it to a customer who has taken a particular action (e.g., purchased something from the merchant, provided a referral, etc.). The award may be made to a particular customer on an individual basis, or as part of a broader loyalty program available to a set of customers or potential customers, or anyone. In this manner, gift certificates of stock may be used by merchants as awards to incentivize certain consumer behavior. Similarly, an employer may purchase and give a gift certificate to an employee as a bonus or as part of a compensation package.

In another embodiment, the gift certificates may be created in a way that is tailored to a purchaser wishing to distribute many of them. For example, a merchant may advertise a gift certificate identifier on the web or in a newspaper ad, announcing that the first 100 customers to enter the identifier at the merchant's website (or, for example, the first 100 customers to make a purchase at the merchant's website) will each win $50 worth of the merchant's stock. The amount could be made to diminish for another subsequent number of customers (e.g., the next 50 customers get $25 worth). The provider software would maintain a counter associated with the identifier, and change the amount to be claimed when the counter reached the prespecified levels. Alternatively, the awarded amount could be random or include a random component, so that, for example, the first 100 customers would each win at least $50 worth of stock but could earn up to $1000 worth of stock.

Furthermore, it may be desirable to impose limits on certain transactions. For example, it may be useful to impose an upper (e.g., $500) or lower (e.g., $10) dollar limit on the denomination of the gift certificate. Another example may be a dollar limit on the total value that a purchaser can give a particular recipient (or, in the aggregate, to all recipients) during a certain period of time, e.g., to comply with anti-money laundering laws. As another example, the system may be designed to block purchases of gift certificates of certain kinds of assets by, or for the benefit of, foreigners. Another example is where children are involved, in which case the system may provide parental controls to enable parents to monitor their children's activity or authorize certain activities (either on a per-transaction or on a standing basis) before they can be consummated, and, indeed, may require the account to be set up as a custodial account.

In the purchasing and claiming process described above, an authorization hold is placed on the purchaser's credit card at the time a gift certificate is purchased, and the amount of the purchase is settled at the time of claiming. This may help overcome issues of where, and in whose name, to hold funds or stock until a gift certificate is claimed and a recipient account is available. Alternatively, the payment transaction may be settled earlier, e.g., at the time of purchase. In this case, the purchaser's provider account 212 may be credited with cash in an amount equal to (or some function of) the face value of the gift certificate, or with the appropriate number of shares, depending on when the fixing time 265 is. Or, the cash or shares could be credited to a separate portion of the purchaser's account (which portion is, e.g., inaccessible for trading purposes), or to an escrow account or holding account maintained by the provider that is not specific to a particular purchaser, but instead may hold the aggregate of the face values of unclaimed gift certificates that have been purchased by one or more purchasers, for later reassignment to recipients as the gift certificates are claimed.

It may be desirable to permit companies to provide advertising or other offers that are related in some way to the gift certificate that a purchaser is purchasing or thinking about purchasing. For example, if a purchaser is considering the purchase of a gift certificate good for $25 of Nike stock, an offer for a discount on Nike footwear or a link to Nike's online store could be displayed. Indeed, ads for and offers by other sports and footwear oriented companies—even those of competitors—could be displayed.

The gift certificates of the present invention could be implemented with or without expiration dates. For example, a gift certificate could be assigned an expiration date (e.g., 3 months from date of purchase, 1 year from the event for which the gift is being given) by the provider or purchaser. Should the gift certificate not be claimed by then, the value could revert to the provider or the purchaser, depending on system implementation.

It may be advantageous to give new customers an opportunity to identify people they know who might end up purchasing gift certificates for the customer or receiving gift certificates from the customer. Along these lines, the customer may be provided with a mechanism to upload the contents of an address book (e.g., from Microsoft Outlook®), interface with a social networking website such as Facebook or an event/invitation management site such as Evite, or manually or otherwise enter information for their contacts. The customer also might be prompted to identify schools (e.g. Roosevelt High School Class of '95), colleges, work places, and other past or current affiliations, enabling the system to identify and display other people sharing one or more of those affiliations for possible identification by the customer.

The fractional shares of stock held by provider's customers may be covered by integer shares of stock in ways other than by maintaining a provider inventory as described herein. For example, the provider may instead place trades of integer shares of stock periodically (e.g., every Wednesday). In such an implementation, the trade that is placed for a given company's shares may be based on the aggregate face value of gift certificates for that company's stock that have been claimed during the period (e.g., 4 shares of Company A stock may be purchased on a Wednesday if a total face value of $250 of gift certificates for Coca-Cola stock were claimed in the preceding 7 day period and Coke was trading at $70/share). In that case, the fixing price for the fractional shares may be the same as the price received by the provider for the integer share trade.

As another example, in an embodiment where the provider operates as an introducing broker separate from a clearing broker that places trades, the provider may employ an “offsetting trades” process to cover its customer's fractional share holdings. In this case, when a gift certificate is claimed, a “buy” order for the appropriate fractional amount may be placed with the clearing broker on behalf of the recipient, and an offsetting “sell” order may be placed with the clearing broker on behalf of the provider. The net effect is to transfer a fractional amount of stock from the provider to the recipient, to the extent a direct transfer between provider and customer may be prohibited by regulation or otherwise inappropriate or undesirable.

The present disclosure can be implemented by a general purpose computer programmed in accordance with the principals discussed herein. It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms data memory including non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Those skilled in the art will appreciate that the present invention can be practiced by other than the described embodiments, which are presented for the purposes of illustration and not of limitation, and the present invention is limited only by the claims which follow.

What is claimed:

1. A method for providing a gift of stock in a company from a purchaser to a recipient, the method comprising the steps of:
receiving, from the purchaser, payment information and a gift request comprising the identity of stock in a company, a dollar amount of a gift, and information identifying a recipient;
assigning a gift identifier to the gift request using a processor;
storing the gift identifier and associated gift request in a data memory;
providing notification to the recipient identifying the stock and the dollar amount and the gift identifier;
receiving, from the recipient, a request to claim the gift, the claim request including the gift identifier;
receiving account information from the recipient;
accessing the stored data to identify the associated gift request;
purchasing a number of shares of the identified stock as a function of the accessed data and a price per share for the stock;
receiving payment for the purchased shares using the payment information received from the purchaser; and
crediting the recipient's account with the purchased shares.

2. The method of claim 1 wherein the payment information includes credit card information associated with the purchaser.

3. The method of claim 1 wherein the gift request comprises the identity of stock of at least two companies.

4. The method of claim 1 wherein the identity of the recipient comprises information for a brokerage account associated with the recipient.

5. The method of claim 1 wherein the identity of the recipient comprises an e-mail address associated with the recipient.

6. The method of claim 1 wherein the step of providing notification includes providing an electronic link to the recipient to facilitate the step of receiving a request to claim the gift.

7. The method of claim 1 wherein the step of receiving a request to claim the gift includes displaying a webpage to the recipient to facilitate receiving the request to claim.

8. The method of claim 1 wherein the step of receiving account information from the recipient includes receiving information for creating a new account for the recipient.

9. The method of claim 1 wherein the number of shares is a non-integer number.

10. The method of claim 1 wherein the step of purchasing shares of the identified stock occurs before the step of receiving a request from the recipient to claim the gift.

11. The method of claim 1 wherein the step of receiving payment occurs before the step of receiving a request from the recipient to claim the gift.

12. A method for enabling a gift of stock from a purchaser to a recipient, the method comprising the steps of:
receiving, from the purchaser, a gift request comprising a dollar amount of a gift;
assigning a gift identifier to the gift request using a processor;
storing the gift identifier and associated gift request in a data memory;
receiving, from the recipient, a request to claim the gift, the claim request including the gift identifier;
associating the identifier with stock in one or more companies; and
crediting an account held by the recipient with a number of shares of stock determined as a function of the dollar amount of the gift.

13. The method of claim 12 wherein the gift request identifies the one or more companies whose stock is associated with the gift identifier.

14. The method of claim 12 wherein the claim request identifies the one or more companies whose stock is associated with the gift identifier.

15. The method of claim 12 wherein the step of associating occurs before the step of receiving a claim request from the recipient.

16. The method of claim 12 wherein the claim request includes anti-fraud information.

17. The method of claim 16 wherein the anti-fraud information includes at least one of: a phone number, a password, a question/answer pair, a pseudo-randomly generated string, and information known to both the purchaser and recipient.

18. The method of claim 16 wherein the anti-fraud information is provided to the recipient in addition to the identifier.

19. The method of claim 12 further comprising the additional steps of:
receiving payment information from the purchaser; and
purchasing the shares of the identified stock using the payment information, the stored data, and a price per share for the stock.

20. The method of claim 12 wherein the shares of the identified stock are obtained from an account held by the purchaser.

21. A method for enabling a gift of stock, the method comprising the steps of:
receiving, from a purchaser, payment information and a gift request;
assigning a gift identifier to the gift request;
storing the gift identifier and associated gift request;
purchasing a number of shares of stock in one or more companies as a function of the gift request and a price per share of stock in the one or more companies;
receiving payment for the purchased shares using the payment information received from the purchaser;
receiving, from a recipient, a request to claim the gift, the claim request including the gift identifier; and
crediting the purchased shares to an account held by the recipient.

22. The method of claim 21 wherein the recipient is not identified by the purchaser.

23. The method of claim 21 wherein the identity of the recipient is not known to the purchaser.

24. The method of claim 21 wherein the step of purchasing occurs after the step of receiving, from the recipient, a request to claim the gift.

25. The method of claim 21 wherein the gift request specifies a dollar amount of the gift.

26. The method of claim 21 wherein the gift request specifies a number of shares of stock in each of one or more companies.

27. The method of claim 26 wherein the number of shares is not an integer.

28. The method of claim 21 wherein the one or more companies are specified by the recipient.

29. The method of claim 21 wherein the one or more companies and corresponding dollar amounts are specified by the recipient, wherein the sum of the corresponding dollar amounts does not exceed the dollar amount of the gift.
